(19) United States
(12) Patent Application Publication
(10) Pub. No.: US 2012/0224049 A1
(43) Pub. Date: Sep. 6, 2012

(54) CLEARANCE INSPECTION APPARATUS FOR A MACHINE

(75) Inventor: David Richard Cox, St. Petersburg, FL (US)

(73) Assignee: GENERAL ELECTRIC COMPANY, Schenectady, NY (US)

(21) Appl. No.: 13/040,387

(22) Filed: Mar. 4, 2011

(51) Int. Cl. H04N 7/18

(52) U.S. Cl. 348/92; 348/E07.085

(57) ABSTRACT

Systems for inspecting clearances in a machine are disclosed. In one embodiment, an apparatus for inspecting a clearance in a machine includes: a base bracket configured to be disposed upon at least one rotor land within the machine; an optical device disposed upon the base bracket, the optical device for capturing an image of at least a portion of the machine wherein the image depicts at least one clearance in the machine; and a computing device communicatively connected to the optical device, the computing device for obtaining and processing the image of at least a portion of the machine from the optical device and determining at least one clearance value from the image.

### BACKGROUND OF THE INVENTION

The subject matter disclosed herein relates to machines and, more particularly, to a system for inspecting clearances in machines, particularly turbines.

Some power plant systems, for example certain nuclear, simple-cycle and combined-cycle power plant systems, employ turbines in their design and operation. These turbines include rotors which are used to convert thermal energy into rotary motion for use and conversion by power plant systems and generators. These rotors are located within a diaphragm and are driven by a gas (i.e. steam) traveling through the diaphragm. To increase efficiency of the turbine, clearances between turbine elements are minimized and packing elements are used to seal and disrupt channels where the gas may avoid driving the rotors, instead directing a maximum amount of the gas flow into the rotors. Thermal variances and prolonged turbine use have an effect on these clearances, causing diaphragm dishing and both turbine and packing elements to undergo physical changes. The expansion, contraction, damage and wear of turbine and packing elements which comes from turbine operation may cause deviations from the original operational clearances designed for these elements. Further, diaphragm dishing may cause variances in clearances, increased outage costs and inefficient operation. The repair time and costs associated with these clearance variances increase the longer they go undetected. Therefore, it is desirable to quickly, accurately and reliably measure the clearances within a turbine, thereby enabling early detection and correction of clearance variances. Some power plant systems measure clearances manually by use of a taper gage, requiring a technician to slide a tapered instrument into the clearances between the turbine and packing elements and then read and record the measurement. However, these systems are imprecise, time consuming and susceptible to human error, they also fail to provide an accurate, reviewable record of clearances.

### BRIEF DESCRIPTION OF THE INVENTION

Systems for inspecting clearances in a machine are disclosed. In one embodiment, an apparatus for inspecting a clearance in a machine includes: a base bracket configured to be disposed upon at least one rotor land within the machine; an optical device disposed upon the base bracket, the optical device for capturing an image of at least a portion of the machine wherein the image depicts at least one clearance in the machine; and a computing device communicatively connected to the optical device, the computing device for obtaining and processing the image of at least a portion of the machine from the optical device and determining at least one clearance value from the image.

A first aspect of the disclosure provides an apparatus for inspecting a clearance in a machine includes: a base bracket configured to be disposed upon at least one rotor land within the machine; an optical device disposed upon the base bracket, the optical device for capturing an image of at least a portion of the machine wherein the image depicts at least one clearance in the machine; and a computing device communicatively connected to the optical device, the computing device for obtaining and processing the image of at least a portion of the machine from the optical device and determining at least one clearance value from the image.

A second aspect provides an inspection system including: a base bracket configured to be disposed upon at least one rotor land within a machine; an optical device disposed upon the base bracket, the optical device for capturing an image of at least a portion of the machine; and at least one computing device communicatively connected to the optical device, the at least one computing device adapted to inspect the machine by performing actions comprising: obtaining an image of the machine from the optical device; converting pixels in the image into known measurable dimensions; and determining clearance values of the machine from the image.

A third aspect provides a turbine imaging device comprising: a computing device configured to process an image of a turbine to determine at least once clearance value; an optical device communicatively connected to the computing device, the optical device configured to capture an image of the turbine and transmit the image to the computing device; and a base bracket system fluidly connected to the optical device, the base bracket system including: a first base member configured to be disposed upon a first rotor land within the turbine; a second base member operably connected to the first base member and configured to be disposed upon a second rotor land within the turbine; and an optical device mount disposed upon either or both of the first base member and the second base member.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a schematic top view of an embodiment of an apparatus for inspecting a clearance in a machine in accordance with an aspect of the invention;

FIG. 2 shows a schematic top view of an embodiment of a base bracket system in accordance with an aspect of the invention;

FIG. 3 shows a schematic top view of an embodiment of a base bracket system in accordance with an aspect of the invention;

FIG. 4 shows a schematic top view of an embodiment of a base bracket system in accordance with an aspect of the invention;

FIG. 5 shows a schematic top view of an embodiment of an apparatus for inspecting a clearance in a machine in accordance with an aspect of the invention;

FIG. 6 shows a schematic side view of an embodiment of an apparatus for inspecting a clearance in a machine in accordance with an aspect of the invention;

FIG. 7 shows a schematic top view of some of the operational clearances in a turbine system in accordance with an aspect of the invention;

FIG. 8 shows a schematic top view of an embodiment of an apparatus for inspecting a clearance in a machine in accordance with an aspect of the invention;

FIG. 9 shows a schematic view of an embodiment of portions of a multi-shaft combined cycle power plant in accordance with an aspect of the invention; and

FIG. 10 shows a schematic view of an embodiment of a single shaft combined cycle power plant in accordance with an aspect of the invention.

It is noted that the drawings of the disclosure may not be to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As indicated above, aspects of the invention provide for systems configured to inspect clearances in a machine, (for example, e.g. a driving machine, a turbine, a gas turbine, a steam turbine, a compressor, a generator etc.) by using an optical device. The optical device (i.e. a digital camera, borescope, etc.) is positioned on a base bracket at a set horizontal and vertical distance and a set orientation relative to at least a portion of the machine, the set horizontal and vertical distances and set orientation being known by a computing device communicably connected to the optical device. The optical device is used to capture an image of at least a portion of the machine, thereby creating an accurate record of any element positions and clearances depicted in the image. The image is transmitted to the computing device where, based upon the known resolution, dimensions and orientation, the pixels in the image are then converted into measurable dimensions by the computing device and any of a number of clearance values in the image are determined based upon the converted pixels.

In the art of power generation systems (including, e.g., nuclear reactors, steam turbines, gas turbines, etc.), machines with small working clearances are often employed as part of the system. For instance, turbines with encased rotors are often used to drive a power generator for the purpose of generating electricity. Typically, the elements within the turbine, including the rotor and casing operate with small working clearances to maximize efficiency, even including packing elements in design and construction to seal and reduce clearances and channels within the turbine where gas may avoid driving the rotors. By reducing the clearances between the various elements of the turbine, more gas is forced to travel through, and subsequently drive, the rotors instead of leaking through these clearances. However, as the turbine is operated, the clearances between elements begin to vary in size, becoming larger or smaller as operational lifetime extends, resulting in wear or damage to the turbine, poor outage quality, diaphragm dishing, diaphragm creep, inefficient operation, longer outage times, higher repair costs, etc. These clearance variances are difficult to detect and accurately record and their negative effects are amplified over time, e.g. the longer they go undetected by operators the greater the costs to the system.

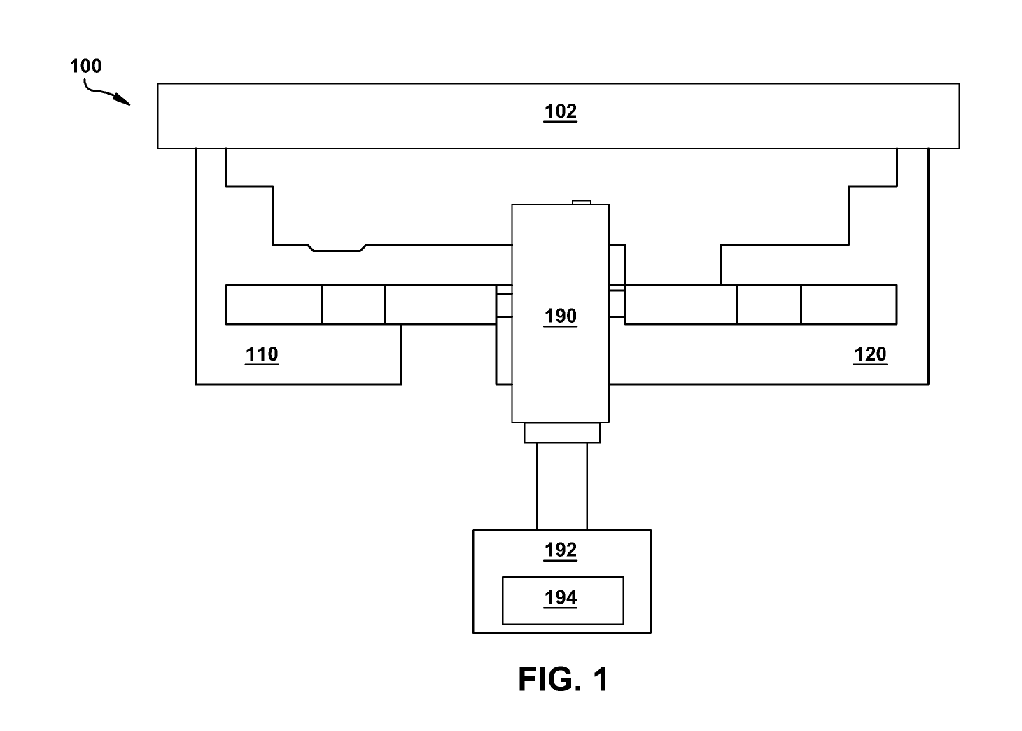

Turning to the FIGURES, embodiments of a clearance inspection system for a machine such as a turbine are shown, where the clearance inspection system may allow for increases in efficiency and life expectancy of the diaphragm, the rotors, the turbine and the overall power generation system by quickly and accurately identifying clearances between turbine elements which vary from designed operational clearance values. Each of the components in the FIGURES may be connected via conventional means, e.g., via a wired communication, wireless communication, common conduit or other known means as is indicated in FIGS. 1-10. Specifically, referring to FIG. 1, a schematic top view of a clearance inspection system 100 in accordance with an aspect of the invention is shown. Clearance inspection system 100 may include a first base member 110 operably connected to a second base member 120, an optical device 190 disposed upon either or both of first base member 110 and second base member 120 and a computing device 192 communicatively connected to optical device 190. Clearance inspection system 100 may be disposed upon a portion of a turbine 102, where first base member 110 and second base member 120 may be in contact with turbine 102 positioning optical device 190 at a set orientation and horizontal and vertical distance relative to at least this portion of turbine 102. The set orientation, horizontal and vertical distances being known by computing device 192. Optical device 190 may capture an image of at least a portion of turbine 102, thereby creating a reviewable image which may be processed by computing device 192. Computing device 192 may convert pixels in the image into measurable dimensions by considering the resolution of optical device 190 and the known orientation and horizontal and vertical distances of optical device 190 relative to turbine 102. Computing device 192 may compute clearance values for elements of turbine 102 by considering the converted pixels in the image which represent the clearances. In another embodiment, computing device 192 may include a memory 194 for storing the image. In another embodiment, memory 194 may store the image for local or remote processing. Attachment upon turbine 102 and image processing by computing device 192 may be accomplished in any number of ways as is known in the art or discussed further below.

In an embodiment of the present invention, optical device 190 may be positioned at a center of clearance inspection system 100 between first base member 110 and second base member 120. In one embodiment, pixels in images captured by optical device 190 may be pre-converted to known measurable lengths stored in memory 194 on computing device 192. It is understood that optical device 190 may include a camera, a borescope, etc. It is understood that computing device 192 may include a plurality of computing devices.

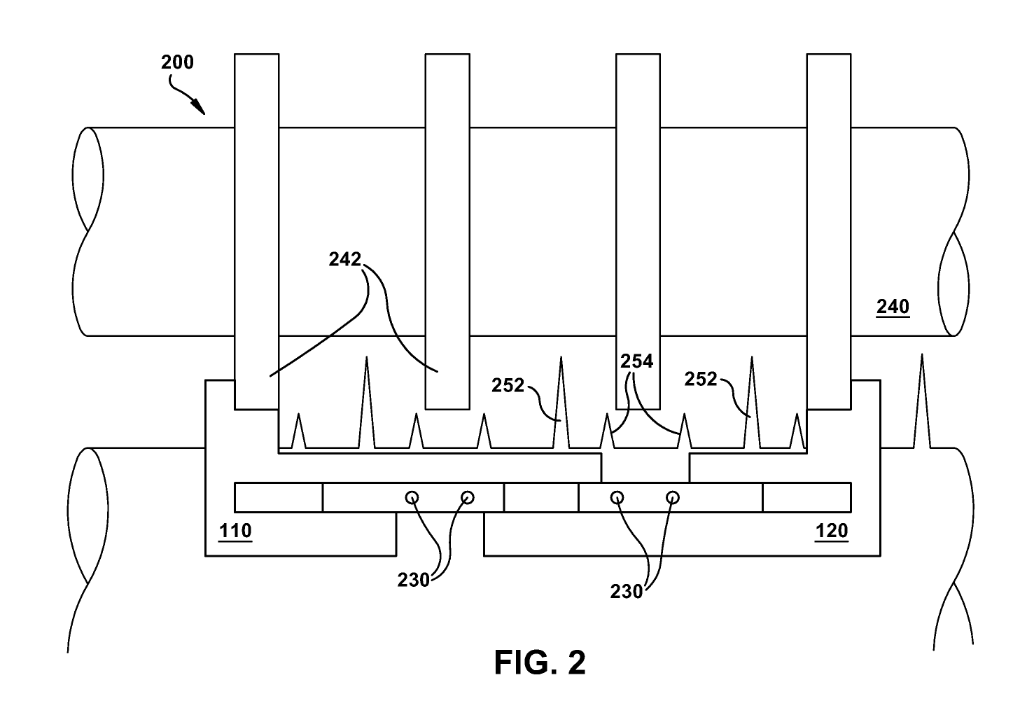

Turning to FIG. 2, a schematic top view of a base bracket system 200 is shown according to embodiments of the invention. It is understood that in embodiments shown and described with reference to FIGS. 2-10, like numbering may represent like elements and that redundant explanation of these elements has been omitted for clarity. Finally, it is understood that the components of FIGS. 1-10 and their accompanying descriptions may be applied to any embodiment described herein. Returning to FIG. 2, in this embodiment, base bracket system 200 may include an optical device mount 230 which may be disposed upon either or both of first base member 110 and second base member 120. In this embodiment, first base member 110 and second base member 120 are configured to be disposed upon rotor 240. In one embodiment, first base member 110 and second base member 120 may be configured to be disposed upon rotor lands 242, positioning optical device mount 230 a known distance and orientation relative to either or both of rotor 240 and rotor lands 242. In one embodiment, first base member 110 and second base member 120 may be configured to position optical device mount 230 a known distance and orientation relative to either or both of large packing teeth 252 and small packing teeth 254. In another embodiment, a width of base bracket system 200 may be adjustable.

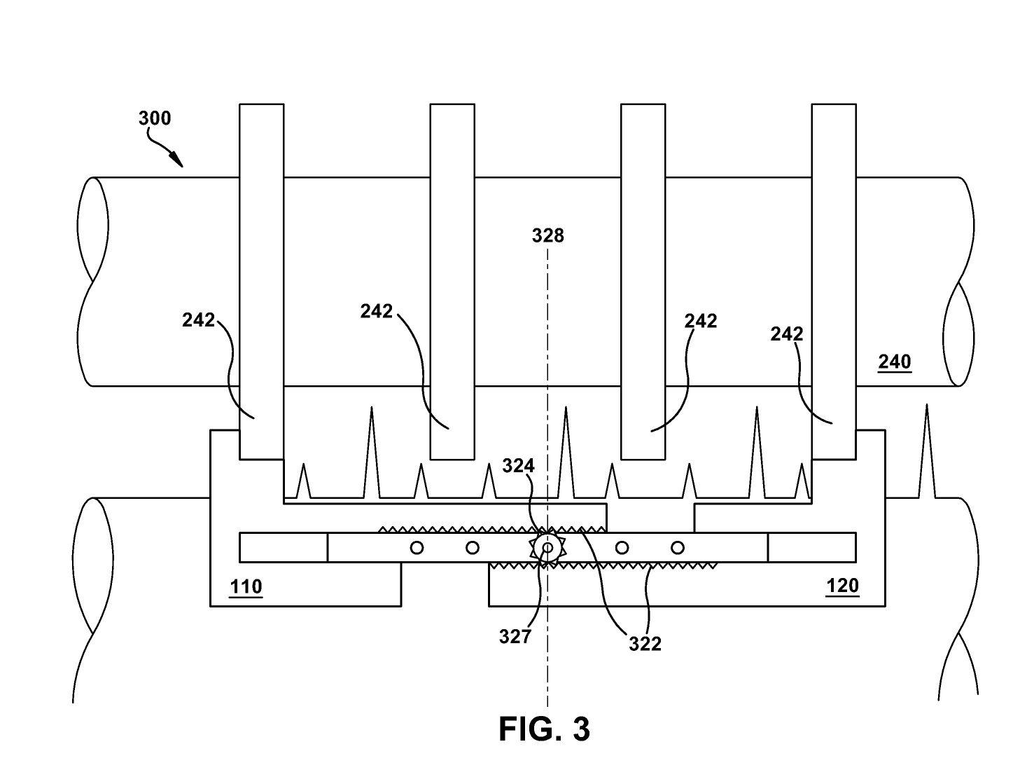

Turning to FIG. 3, a schematic top view of a base bracket system 300 is shown according to embodiments. In this embodiment, base bracket system 300 includes adjustment system 322 for adjusting the positions of first base member 110 and second base member 120 relative to one another. In this embodiment, adjustment system 322 may be used to adjust the width of base bracket system 300 relative to rotor lands 242. In one embodiment, first base member 110 and second base member 120 may be adjusted evenly relative to a center-point 327 of base bracket system 300. In one embodiment, adjustment system 322 may include a geared apparatus 324 between first base member 110 and second base member 120, where the geared apparatus 324 is configured to evenly adjust both first base member 110 and second base member 120 about center-point 327. In another embodiment, first base member 110 and second base member 120 may be adjustable relative to one another such that base bracket system 300 may be disposed upon any of a number of rotor lands 242. In one embodiment, first base member 110 and second base member 120 may slide together or apart to adjust the width of base bracket system 300. In another embodiment, first base member 110 and second base member 120 may be disposed upon rotor 240 such that base bracket system 300 brackets an even number of rotor lands 242. In another embodiment, base bracket system 300 may be disposed upon rotor 240 such that center-point 327 is located at a centerline 328 (shown in phantom) between two rotor lands 242. In another embodiment, adjustment system 322 may enable base bracket system 300 to be interchangeable between different types of turbines.

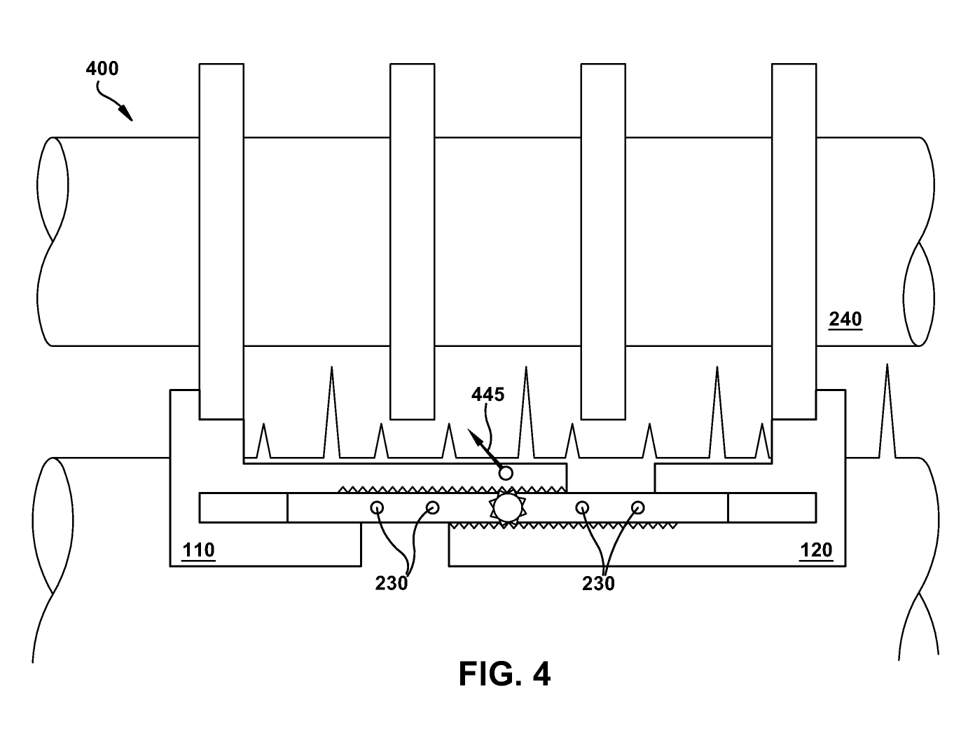

Turning to FIG. 4, a schematic top view of an embodiment of a base bracket system 400 is shown according to embodiments of the invention having a directional indicator 445 disposed upon first base member 110. Directional indicator 445 may be configured to indicate an orientation of rotor 140 relative to base bracket system 400. In one embodiment, directional indicator 445 may be disposed upon either or both of first base member 110 and second base member 120. In another embodiment, directional indicator 445 may be formed as an arrow. In another embodiment, directional indicator 445 may be adjustable. In another embodiment, directional indicator 445 may include a digital display. In another embodiment, directional indicator 445 may be affixed upon rotor 240.

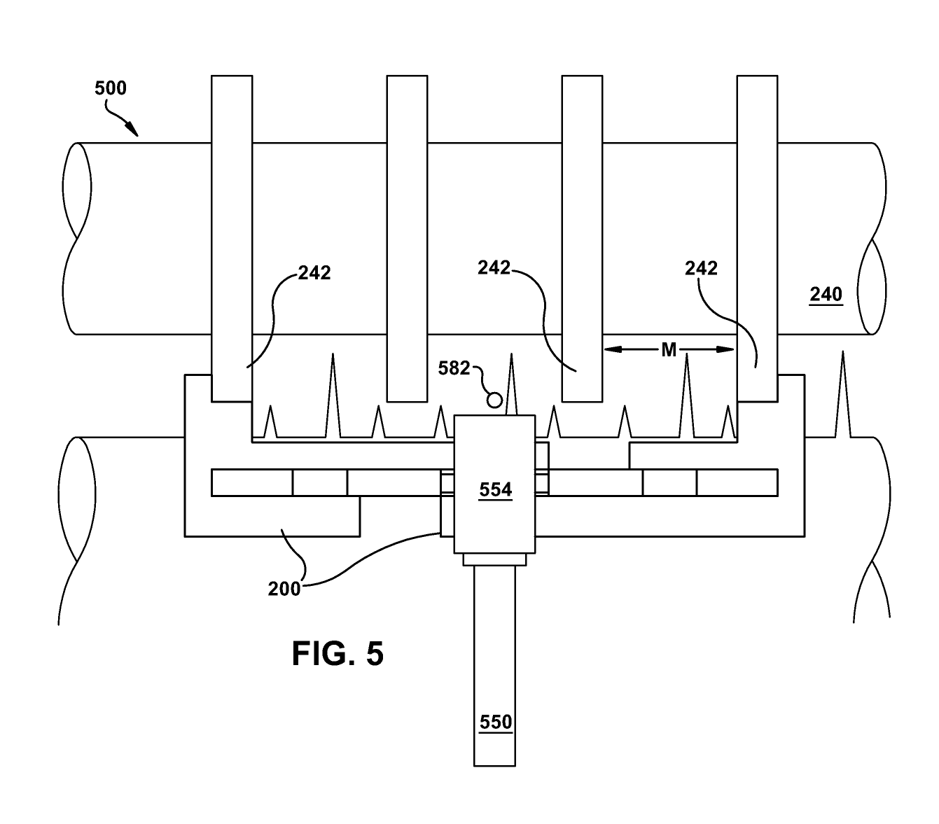

Turning to FIG. 5, a schematic top view of a clearance inspection system 500 according to embodiments of the invention is shown having a borescope 550 disposed within an optical device mount 554. In one embodiment, optical device mount 554 positions borescope 550 at a center of base bracket system 200. In another embodiment, optical device mount 554 may comprise an optical device casing. In another embodiment, optical device mount 554 may secure borescope 550 in a fixed position. In another embodiment, optical device mount 554 may be adjustable. In another embodiment, optical device mount 554 may configure borescope 550 such that a focal point 582 of borescope 550 is located approximately halfway between a set of rotor lands 242 of rotor 240. In another embodiment, optical device mount 554 may be rotatable about focal point 582. In another embodiment, an additional known distance M between rotor packing lands 242 may be obtained from turbine design materials and entered into computing device 192 to assist with converting pixels to measurable dimensions.

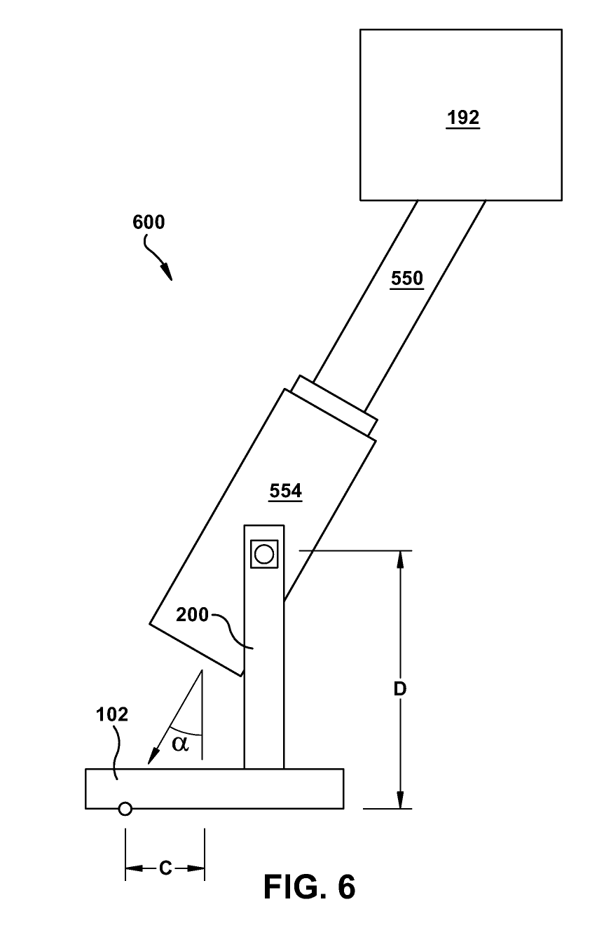

Turning to FIG. 6, a schematic side view of an embodiment of a clearance inspection system 600 according to embodiments of the invention is shown. This illustrates positioning borescope 550 at known distances C and D and angle α relative to a portion of turbine 102. Base bracket system 200 may be disposed upon portions of turbine 102 such that optical device mount 554 consistently configures borescope 550 at known angle α, vertical height D and horizontal distance C relative portions of turbine 102. In one embodiment of the invention, borescope 550 may capture an image of at least a portion of turbine 102 which may be processed by computing device 192. In one embodiment, computing device 192 may convert pixels in the image into known measurable dimensions by considering the resolution of borescope 550, distances C and D and angle α. In another embodiment, computing device 192 may have the resolution of borescope 550, set distances C and D and set angle α stored on memory 194 such that pixels in images captured by borescope 550 may be pre-converted into known measureable distances stored on memory 194.

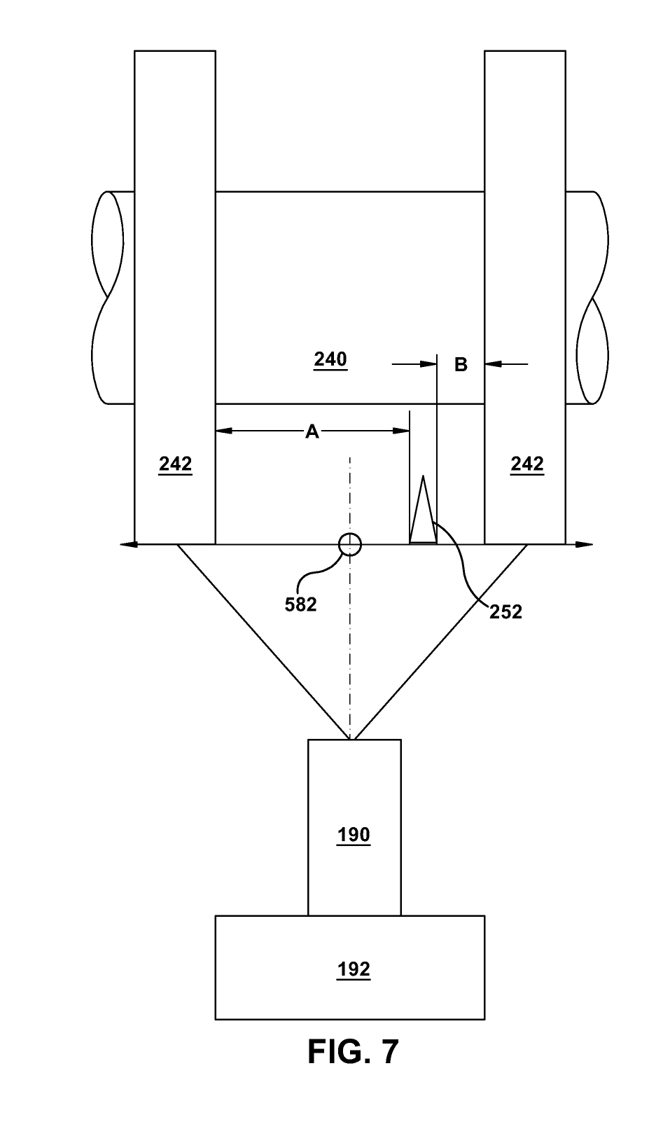

Turning to FIG. 7, a schematic top view illustrating some example axial clearance values A and B is shown according to embodiments of the invention. The values A and B may represent distances between rotor lands 242 of rotor 240 and packing teeth 252. In one embodiment, optical device 190 may be configured with focal point 582 at a center of rotor lands 242 such that A and B will be computable by computing device 192.

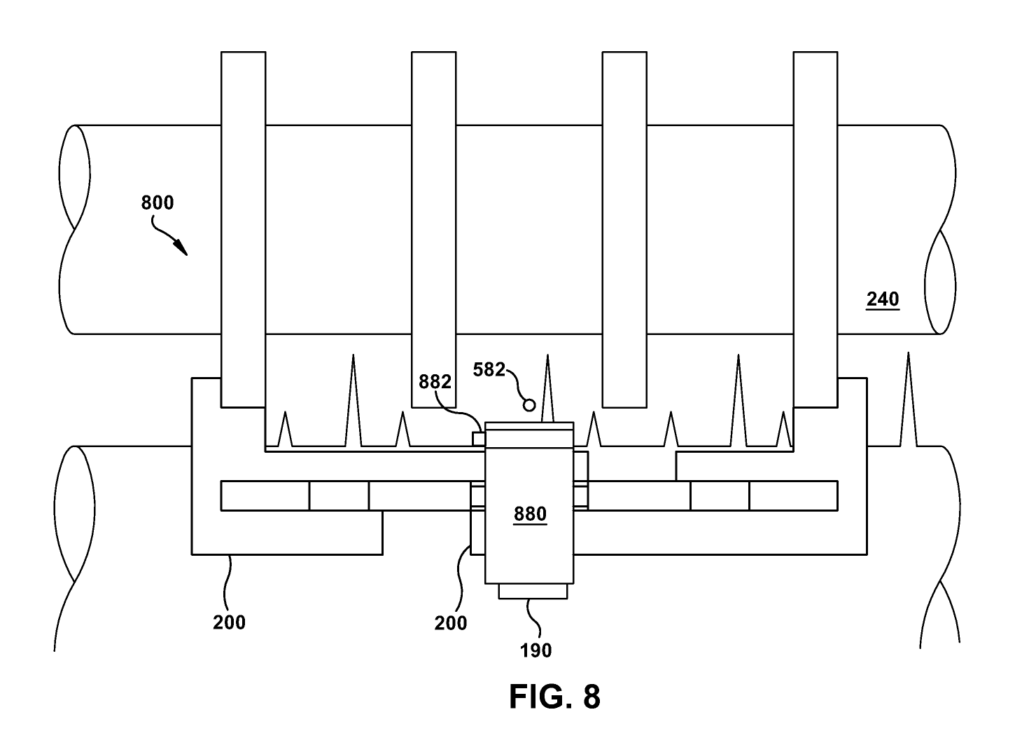

Turning to FIG. 8, a schematic top view of a clearance inspection system 800 is shown according to embodiments of the invention. In this embodiment, clearance inspection system 800 is shown having a rotational optical device casing 880 and a rotational directional indicator 882 disposed upon base bracket system 200. Rotational optical device casing 880 may be configured to dispose optical device 190 upon base bracket system 200. In one embodiment, clearance inspection system 800 may include a rotational directional indicator 882 disposed upon rotational optical device casing 880, rotational directional indicator 882 being configured to be visible in and indicate an orientation of images captured by optical device 190. In one embodiment, rotational optical device casing 880 may be configured to rotate optical device 190 while maintaining a constant focal point position 582 with relation to rotor 140. In another embodiment, rotational directional indicator 882 may rotate with optical device 190 and rotational optical device casing 880.

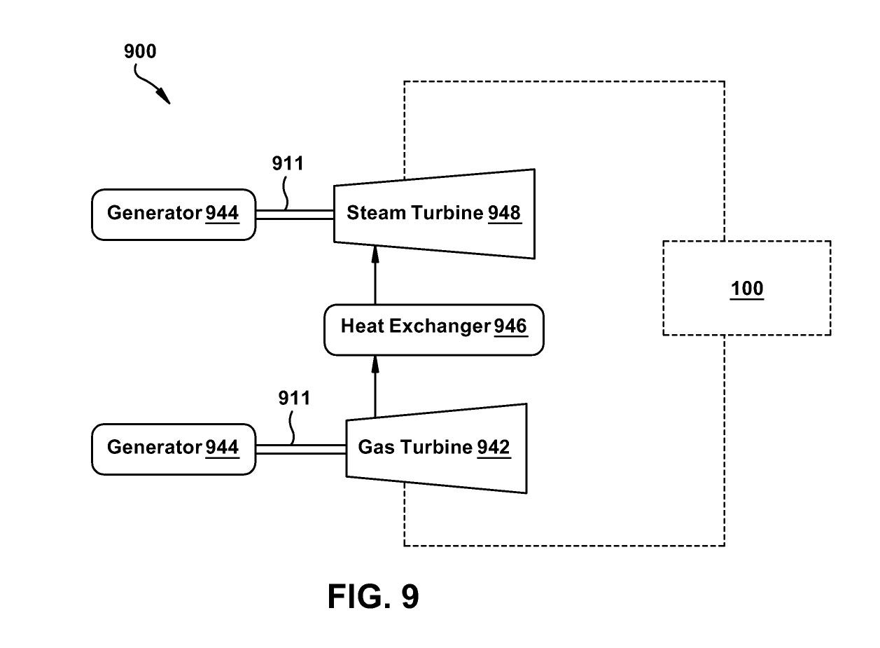

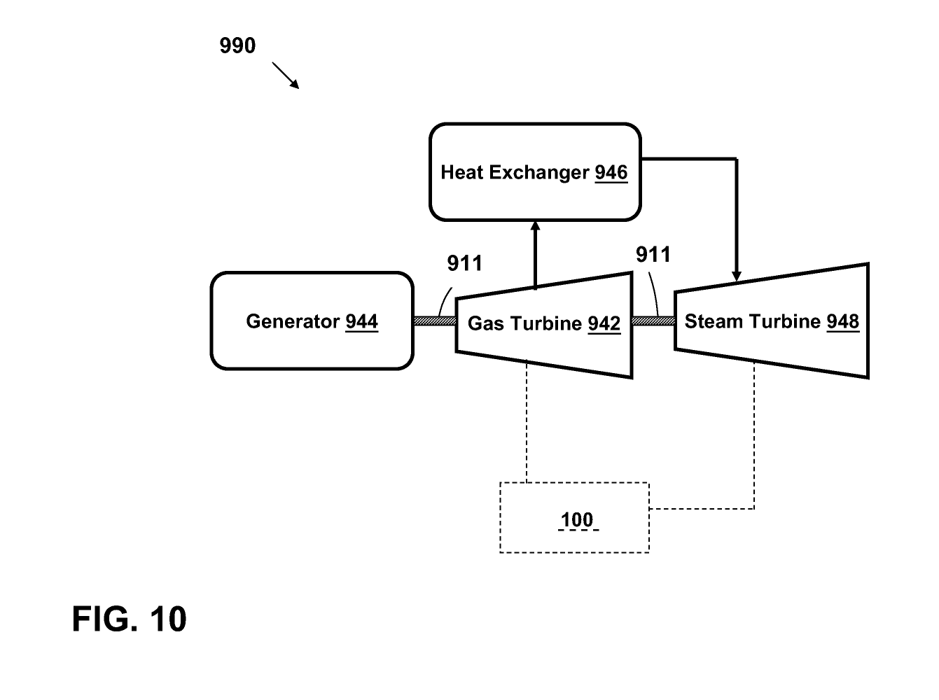

Turning to FIG. 9, a schematic view of portions of a multi-shaft combined-cycle power plant 900 is shown. Combined-cycle power plant 900 may include, for example, a gas turbine 942 operably connected to a generator 944. Generator 944 and gas turbine 942 may be mechanically coupled by a shaft 911, which may transfer energy between a drive shaft (not shown) of gas turbine 942 and generator 944. Gas turbine 942 may be operably connected to clearance inspection system 100 of FIG. 1 or other embodiments described herein. Also shown in FIG. 9 is a heat exchanger 946 operably connected to gas turbine 942 and a steam turbine 948. Heat exchanger 946 may be fluidly connected to both gas turbine 942 and steam turbine 948 via conventional conduits (numbering omitted). Heat exchanger 946 may be a conventional heat recovery steam generator (HRSG), such as those used in conventional combined-cycle power systems. As is known in the art of power generation, HRSG 946 may use hot exhaust from gas turbine 942, combined with a water supply, to create steam which is fed to steam turbine 948. Steam turbine 948 may optionally be coupled to a second generator system 944 (via a second shaft 911). It is understood that generators 944 and shafts 911 may be of any size or type known in the art and may differ depending upon their application or the system to which they are connected. Common numbering of the generators and shafts is for clarity and does not necessarily suggest these generators or shafts are identical. Generator system 944 and second shaft 911 may operate substantially similarly to generator system 944 and shaft 911 described above. Steam turbine 948 may be fluidly connected to clearance inspection system 100 of FIG. 1 or other embodiments described herein. In one embodiment of the present invention (shown in phantom), clearance inspection system 100 may be used to inspect clearances in either or both of steam turbine 948 and gas turbine 942 during an outage. In another embodiment, two clearance inspection systems 100 may be operably connected to combined-cycle power plant 900, one clearance inspection system 100 for each of gas turbine 942 and steam turbine 946. In another embodiment, shown in FIG. 10, a single-shaft combined-cycle power plant 990 may include a single generator 944 coupled to both gas turbine 942 and steam turbine 946 via a single shaft 911. Gas turbine 942 and steam turbine 946 may be fluidly connected to clearance inspection system 100 of FIG. 1 or other embodiments 200, 300, 400, 500, 600, 700, 800 or 900 described herein.

The clearance inspection system of the present disclosure is not limited to any one particular machine, driven machine, turbine, fan, blower, compressor, power generation system or other system, and may be used with other power generation systems and/or systems (e.g., combined-cycle, simple-cycle, nuclear reactor, etc.). Additionally, the clearance inspection system of the present invention may be used with other systems not described herein that may benefit from the early detection, inspection, imaging, recording, and measurement capabilities of the turbine clearance inspection system described herein.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An apparatus for inspecting a clearance in a machine, the apparatus comprising:
a base bracket configured to be disposed upon at least one rotor land within the machine;
an optical device disposed upon the base bracket, the optical device for capturing an image of at least a portion of the machine wherein the image depicts at least one clearance in the machine; and
a computing device communicatively connected to the optical device, the computing device for obtaining and processing the image of at least a portion of the machine from the optical device and determining at least one clearance value from the image.

2. The apparatus of claim 1, wherein the base bracket is configured to position the optical device at a known orientation and distance relative to the machine.

3. The apparatus of claim 2, wherein the computing device is configured to convert pixels in the captured image into known measureable dimensions based upon the resolution of the optical device and the known orientation and distance of the optical device relative to the machine.

4. The apparatus of claim 1, wherein a width of the base bracket is adjustable.

5. The apparatus of claim 1, wherein the machine includes a turbine and the base bracket is configured to attach to a set of rotor lands in the turbine.

6. The apparatus of claim 5, wherein the base bracket is further configured to position the optical device at a center location of an even number of rotor lands.

7. The apparatus of claim 1, wherein the optical device comprises a borescope.

8. The apparatus of claim 1, wherein the computing device is further configured to store the image.

9. The apparatus of claim 1, further comprising a directional indicator disposed upon the base bracket, the directional indicator for indicating an orientation of the image.

10. An inspection system comprising:
a base bracket configured to be disposed upon at least one rotor land within a machine;
an optical device disposed upon the base bracket, the optical device for capturing an image of at least a portion of the machine; and
at least one computing device communicatively connected to the optical device, the at least one computing device adapted to inspect the machine by performing actions comprising:
obtaining an image of the machine from the optical device;
converting pixels in the image into known measurable dimensions; and
determining clearance values of the machine from the image.

11. The inspection system of claim 10, wherein the base bracket is configured to position the optical device at a known orientation and distance relative to the machine.

12. The inspection system of claim 10, wherein a width of the base bracket is adjustable.

13. The inspection system of claim 10, wherein the machine includes a turbine, and the base bracket is disposed upon a set of rotor lands in the turbine.

14. The inspection system of claim 13, wherein the base bracket is further configured to position the optical device at a centerline of an even number of rotor lands.

15. The inspection system of claim 10, wherein the computing device is further configured to store the captured image.

16. The inspection system of claim 10, further comprising a directional indicator disposed upon the base bracket, the directional indicator for indicating an orientation of the image.

17. A turbine imaging device comprising:
a computing device configured to process an image of a turbine to determine at least one clearance value;
an optical device communicatively connected to the computing device, the optical device configured to capture an image of the turbine and transmit the image to the computing device; and
a base bracket system fluidly connected to the optical device, the base bracket system including:
a first base member configured to be disposed upon a first rotor land within the turbine;
a second base member operably connected to the first base member and configured to be disposed upon a second rotor land within the turbine; and
an optical device mount disposed upon either or both of the first base member and the second base member.

18. The turbine imaging device of claim 17, wherein the base bracket system is configured to position the optical device at a known orientation and distance relative to the turbine.

19. The turbine imaging device of claim 17, further comprising an adjustment system operably connected to the first base member and the second base member, the adjustment system being configured to adjust the width of the base bracket system.

20. The turbine imaging device of claim 19, wherein the imaging device mount includes a casing for the optical device, the casing being configured to secure the optical device and rotate the optical device about a central focal point.
